(19) United States
(12) Patent Application Publication
(10) Pub. No.: US 2003/0101971 A1
(43) Pub. Date: Jun. 5, 2003

(54) Grounded fuel delivery module for fuel system

(76) Inventors: Robert L. Farrar, Flint, MI (US); Chris I. Witherspoon, Clarkston, MI (US)

Correspondence Address: VINCENT A. CICHOSZ, DELPHI TECHNOLOGIES, INC., Mail Code: 480-414-420, P.O. Box 5052, Troy, MI, 48007-5052, US

(21) Appl. No.: 09/997,366

(22) Filed: Nov. 30, 2001

(51) Int. Cl. F02M 1/00

(52) U.S. Cl. 123/510

(57) ABSTRACT

A grounded fuel delivery module for a fuel system of a vehicle includes a fuel reservoir and a fuel pump disposed in the fuel reservoir and adapted to pump fuel from a fuel tank of the fuel system to an engine of the vehicle. The grounded fuel delivery module also includes a fuel component disposed in the fuel reservoir and at least one grounding clip contacting the fuel pump and the fuel component to complete an electrical circuit used for grounding the fuel component.

### TECHNICAL FIELD

The present invention relates generally to fuel systems for vehicles and, more particularly, to a grounded fuel delivery module for a fuel system of a vehicle.

### BACKGROUND OF THE INVENTION

It is known to provide a fuel system for a vehicle, which includes a fuel delivery module, a fuel filter, a fuel pressure regulator, a fuel rail, and fuel injectors. As the volatility of fuels has been decreased by government regulations, it has become necessary to provide a mechanism of dissipating charges which can develop in a fuel system as a result of fuel flow or movement of fuel within the fuel system under some environmental conditions. As a result, the fuel delivery module must be grounded for proper operation. Typically, small electrical wiring harnesses have been used, which require highly labor intensive assembly methods or utilize expensive conductive plastics that have no fuel system exposure history.

It is desirable to provide a new grounding device for a fuel delivery module in a fuel system for a vehicle. It is also desirable to provide a grounded fuel delivery module for a fuel system of a vehicle that eliminates small electrical wiring harnesses and reduces assembly. It is further desirable to provide a grounded fuel delivery module that is easily adapted for manufacturing. Therefore, there is a need in the art to provide a grounded fuel delivery module for a fuel system that meets these desires.

### SUMMARY OF THE INVENTION

It is, therefore, one object of the present invention to provide a grounded fuel delivery module for a fuel system of a vehicle.

It is another object of the present invention to provide a grounded fuel delivery module for a fuel system of a vehicle that minimizes assembly time.

To achieve the foregoing objects, the present invention is a grounded fuel delivery module for a fuel system of a vehicle including a fuel reservoir and a fuel pump disposed in the fuel reservoir and adapted to pump fuel from a fuel tank of the fuel system to an engine of the vehicle. The grounded fuel delivery module also includes a fuel component disposed in the fuel reservoir and at least one grounding clip contacting the fuel pump and the fuel component to complete an electrical circuit used for grounding the fuel component.

One advantage of the present invention is that a grounded fuel delivery module is provided for a fuel system of a vehicle. Another advantage of the present invention is that the grounded fuel delivery module utilizes proven electrical connection methods. Yet another advantage of the present invention is that the grounded fuel delivery module minimizes assembly time. Still another advantage of the present invention is that the grounded fuel delivery module is easily adapted for manufacturing.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a grounded fuel delivery module, according to the present invention, illustrated in operational relationship with a fuel tank.

FIG. 2 is a perspective view of the grounded fuel delivery module of FIG. 1.

FIG. 3 is a partial perspective view of a portion of the grounded fuel delivery module of FIG. 1.

FIG. 4 is a partial plan view of the portion of the grounded fuel delivery module of FIG. 1.

FIG. 5 is a perspective view of a grounding clip of the grounded fuel delivery module of FIG. 1.

FIG. 6 is a fragmentary elevational view of the grounding clip and fuel pump of the grounded fuel delivery module of FIG. 1.

FIG. 7 is a fragmentary elevational view of the grounding clip and fuel component of the grounded fuel delivery module of FIG. 1.

### DESCRIPTION OF THE PREFERRED EMBODIMENT

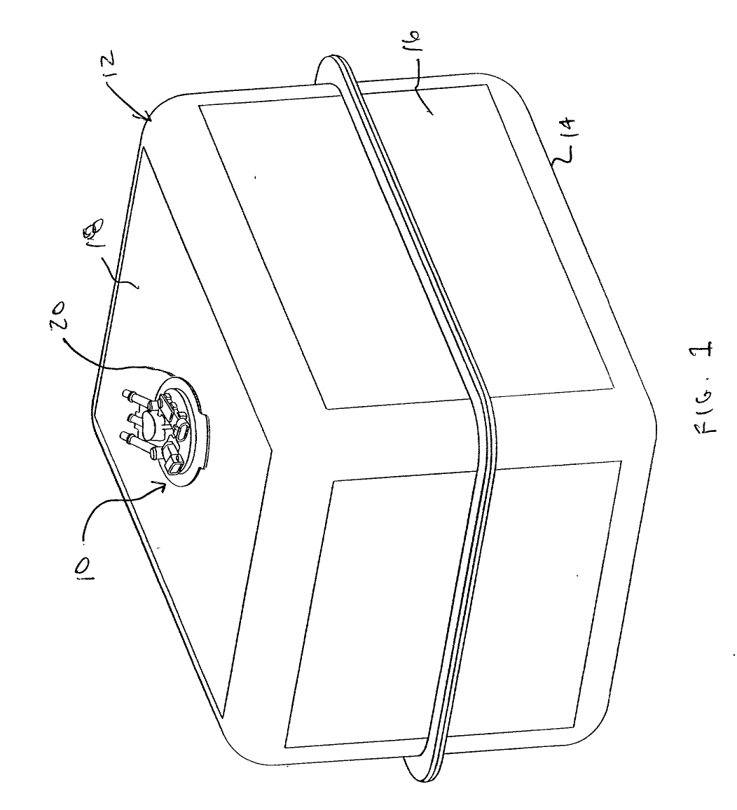

Referring to the drawings and in particular FIG. 1, one embodiment of a grounded fuel delivery module 10, according to the present invention, is shown for a fuel system (not shown) of a vehicle (not shown) The grounded fuel delivery module 10 is used with a fuel tank, generally indicated at 12, to hold liquid fuel. In this embodiment, the fuel tank 12 includes a bottom or base wall 14 and a side wall 16 around a periphery of the base wall 14 and extending generally perpendicular thereto. The fuel tank 12 also includes a top wall 18 extending generally perpendicular to the side wall 16 to form an interior chamber to hold fuel. The top wall 18 includes an opening 20 therein for a function to be described. The fuel tank 12 is made of a rigid material, preferably a plastic material. It should be appreciated that the fuel tank 12 could be made of a metal material such as steel.

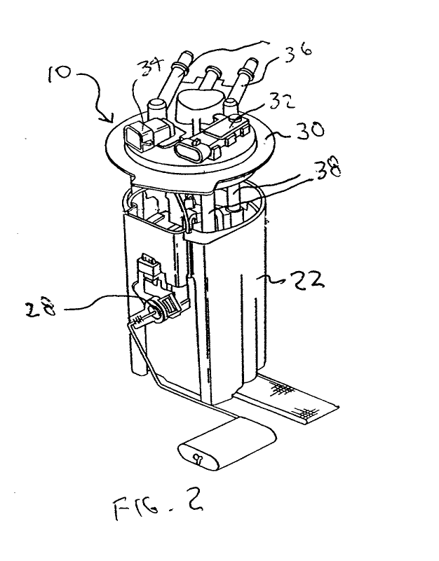

Referring to FIGS. 1 and 2, the grounded fuel delivery module 10 is disposed in the interior chamber and delivers fuel from the fuel tank 12 to an engine (not shown) of the vehicle. The grounded fuel delivery module 10 includes a fuel reservoir 22 having an electrical fuel pump 24 mounted therein. The fuel reservoir 22 is made of a non-conductive material. The fuel pump 24 has a metal shell 26 attached to an internal electrical ground (not shown) therein. The grounded fuel delivery module 10 also includes a fuel level indication mechanism 28 such as a rheostat connected to the fuel reservoir 22 for indicating the level of the fuel inside the fuel tank 12. The fuel level indication mechanism 28 is made of a non-conductive material. It should be appreciated that the fuel reservoir 24, fuel pump 26, and fuel level indication mechanism 28 are conventional and known in the art.

The grounded fuel delivery module 10 includes a cover 30 to close the opening 20 in the fuel tank 12. The cover 30 includes an electrical connector 32 and a thermistor or onboard diagnostic sensor 34 connected to the cover 30. The cover 30 is made of a metal material. It should be appreciated that the cover 30 is electrically grounded by fuel lines (not shown) connected to fuel tubes 36 of the cover 30.

The grounded fuel delivery module 10 further includes a plurality of guide rods or tubes 38 to mechanically connect the cover 30 with the fuel reservoir 24. The guide rods 38 are made from either a metal or conductive plastic. The grounded fuel delivery module 10 includes a pump harness (not shown) electrically connected to the electrical connector 32 and the fuel pump 24. It should be appreciated that the fuel pump 24 is electrically connected and grounded to a vehicle electrical system (not shown) through the pump harness and the electrical connector 32.

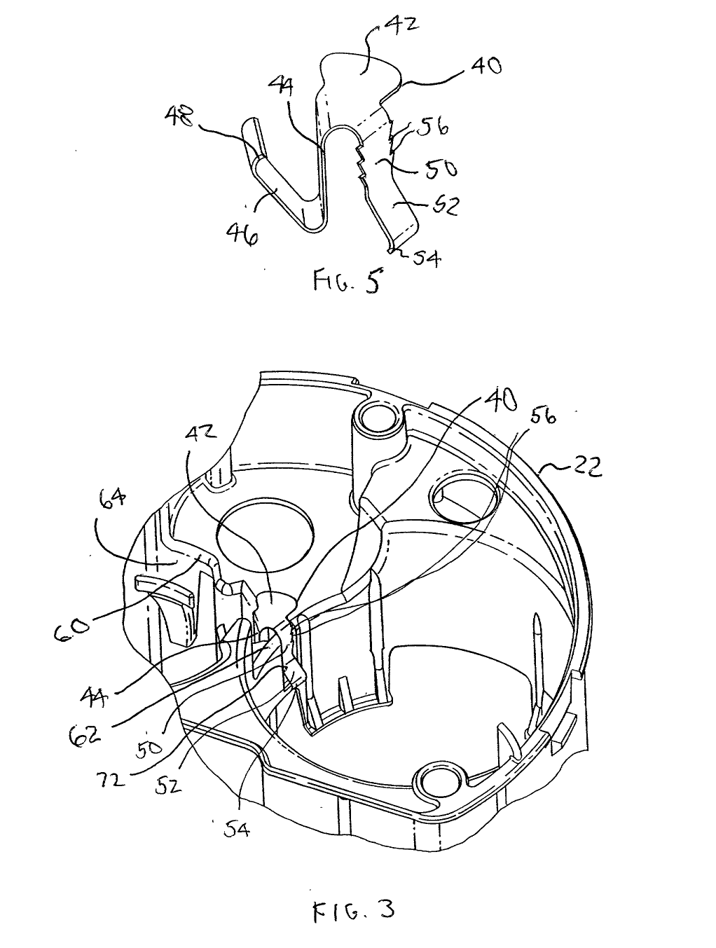

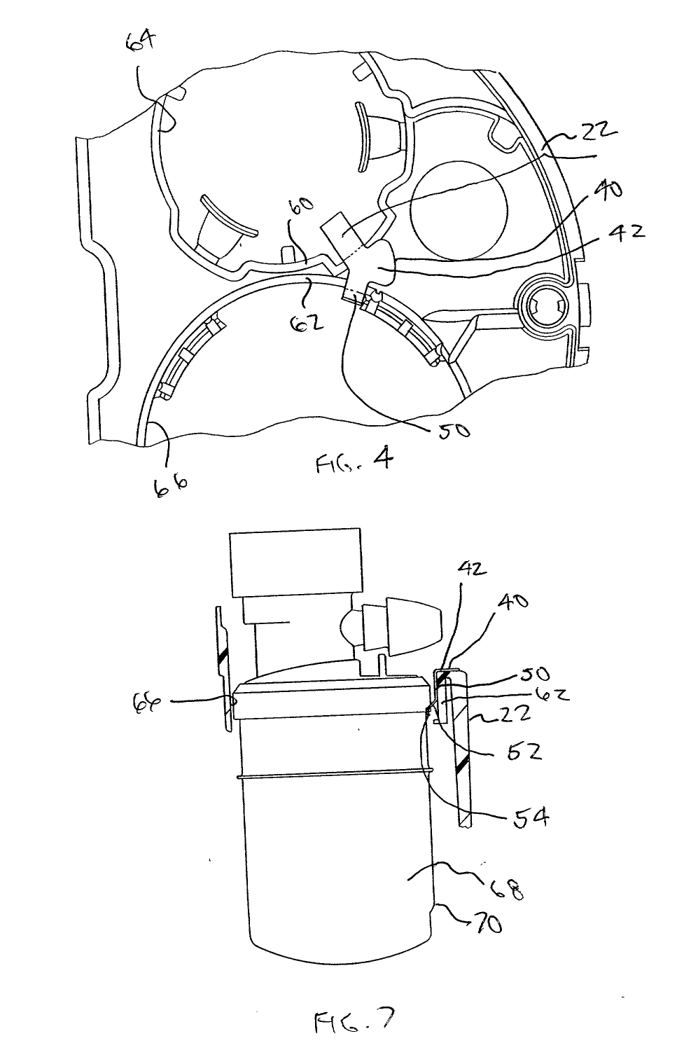

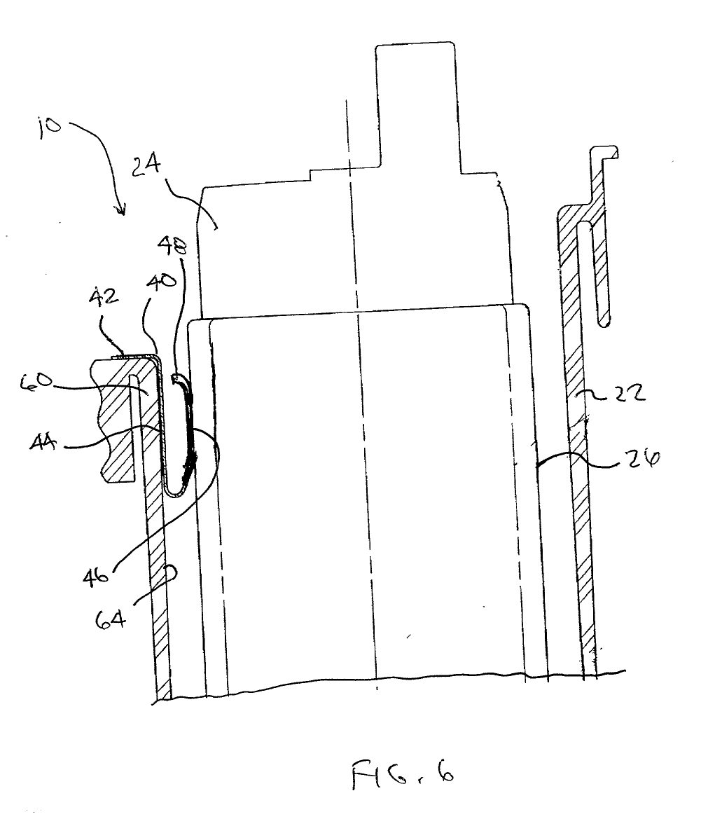

Referring to FIGS. 3 through 7 the grounded fuel delivery module 10 includes a grounding clip 40 disposed in the fuel reservoir 22 and cooperating with the fuel pump 24. The grounding clip 40 has a base 42 that is generally planar and circular in shape. The grounding clip 40 also has a first leg 44 extending downwardly and generally perpendicular from the base 42 and a first engagement arm 46 extending upwardly and outwardly at an angle from the first leg 44. The grounding clip 40 has a first flange 46 extending inwardly from a free end of the engagement arm 46. The first flange 46 has a generally arcuate shape. The grounding clip 40 also has a second leg 50 extending downwardly and generally perpendicularly from the other side of the base 42 and a second engagement arm 52 extending downwardly and outwardly at an angle from the second leg 50. The grounding clip 40 has a second flange 54 extending inwardly from a free end of the second engagement arm 52. The second flange 54 has a generally arcuate shape. The second engagement arm 52 may include at least one, preferably a plurality of barbs 56 extending upwardly and outwardly for a function to be described. The grounding clip 40 is made of a conductive material such as metal or a conductive plastic. The grounding clip 40 is a monolithic structure being integral, unitary, and one-piece. It should be appreciated that the first and second engagement arms 46 and 52 are deflectable.

The grounding clip 40 is disposed in the fuel reservoir 22. The grounding clip 40 is disposed over a pair of cavity walls 60 and 62 of the fuel reservoir 22 such that the cavity walls 60 and 62 are disposed between the first leg 44 and the second leg 50. In one embodiment, the first engagement arm 46 is disposed in a first cavity 64. When the fuel pump 24 is disposed in the first cavity 64, the fuel pump 24 deflects the first engagement arm 46 and is in spring-loaded contact with the shell 26 of the fuel pump 24. The second engagement arm 52 is disposed in a second cavity 66. When a fuel component such as a fuel filter 68 is disposed in the second cavity 66, the fuel filter 68 deflects the second engagement arm 52 and is in spring loaded contact with a shell 70 of the fuel filter 68, insuring a reliable durable connection. The shell 70 of the fuel filter 68 is made of a conductive material such as metal or conductive plastic. When this happens, an electrical connection is made between the fuel filter 68 and fuel pump 24, grounding the components. The barbs 56 of the second engagement arm 52 grip sides of a recess 72 in the second cavity wall 62 to prevent the grounding clip 40 from disengaging the fuel reservoir 22. The grounding clip 40 is pressed over the cavity walls 60 and 62 for minimal assembly time. It should be appreciated that the shell 26 is electrically connected, internal to the fuel pump 24, with the ground terminal of the fuel pump 24. It should also be appreciated that the grounding clip 40 completes an electrical circuit used for grounding of the fuel components in contact therewith and electrically connected to the shell 26 of the fuel pump 24. It should further be appreciated that an end of the grounding clip 40 could extend completely around either the shell 26 of the fuel pump 24 or the fuel component.

The grounded fuel delivery module 10 includes other conductive/dissipative fuel components in contact with the grounding clips 40. It should be appreciated that all fuel components are grounded as long as there is a ground through the fuel pump 24.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A grounded fuel delivery module for a fuel system of a vehicle comprising:
a fuel reservoir;
a fuel pump disposed in said fuel reservoir and adapted to pump fuel from a fuel tank of the fuel system to an engine of the vehicle;
a fuel component disposed in said fuel to reservoir; and
at least one grounding clip contacting said fuel pump and said fuel component to complete an electrical circuit used for grounding said fuel component.

2. A grounded fuel delivery module as set forth in claim 1 wherein said at least one grounding clip is made of a conductive material.

3. A grounded fuel delivery module as set forth in claim 1 wherein said fuel pump is electrically grounded to an electrical system of the vehicle.

4. A grounded fuel delivery module as set forth in claim 1 wherein said fuel component is a fuel filter made of a conductive material.

5. A grounded fuel delivery module as set forth in claim 1 wherein said fuel pump has a metal shell.

6. A grounded fuel delivery module as set forth in claim 1 wherein said at least one grounding clip has a base and a first leg extending downwardly from one side of the base and a second leg extending downwardly from another side of said base.

7. A grounded fuel delivery module as set forth in claim 6 wherein said at least one grounding clip has a first engagement arm extending upwardly and outwardly at an angle from said first leg and a second engagement arm extending downwardly and outwardly at an angle from said second leg.

8. A grounded fuel delivery module as set forth in claim 7 wherein said at least one grounding clip has a first flange extending inwardly from said first engagement arm and a second flange extending inwardly from the second engagement arm.

9. A grounded fuel delivery module as set forth in claim 3 wherein said first flange and said second flange are generally arcuate in shape.

10. A grounded fuel delivery module as set forth in claim 7 wherein said second engagement arm has a plurality of barbs extending upwardly and outwardly.

11. A grounded fuel delivery module comprising:
a fuel reservoir adapted to be disposed in an interior chamber of a fuel tank;
a fuel pump having a metal shell disposed in said fuel reservoir and adapted to pump fuel from the fuel tank to an engine of a vehicle;
at least one fuel component disposed in said fuel reservoir; and
at least one grounding clip made of a conductive material contacting said fuel pump and said at least one fuel component to complete an electrical circuit used for grounding said at least one fuel component.

12. A grounded fuel delivery module as set forth in claim 11 wherein said fuel pump is electrically grounded to an electrical system of the vehicle.

13. A grounded fuel delivery module as set forth in claim 11 wherein said fuel component is a fuel filter made of a conductive material.

14. A grounded fuel delivery module as set forth in claim 11 wherein said at least one grounding clip has a base and a first leg extending downwardly from one side of the base and a second leg extending downwardly from another side of said base.

15. A grounded fuel delivery module as set forth in claim 14 wherein said at least one grounding clip has a first engagement arm extending upwardly and outwardly at an angle from said first leg and a second engagement arm extending downwardly and outwardly at an angle from said second leg.

16. A grounded fuel delivery module as set forth in claim 15 wherein said at least one grounding clip has a first flange extending inwardly from said first engagement arm and a second flange extending inwardly from the second engagement arm.

17. A grounded fuel delivery module as set forth in claim 16 wherein said first flange and said second flange are generally arcuate in shape.

18. A grounded fuel delivery module as set forth in claim 15 wherein said second engagement arm has a plurality of barbs extending upwardly and outwardly.

19. A grounded fuel delivery module as set forth in claim 15 wherein said fuel reservoir has a first wall forming a first cavity and a second wall forming a second wall, said first wall and said second wall being disposed between said first leg and said second leg and said first engagement arm being disposed in said first cavity and said second engagement arm being disposed in said second cavity.

20. A grounded fuel system for a vehicle comprising:
a fuel tank having an interior chamber and an opening therein;
a fuel reservoir disposed in said interior chamber of said fuel tank, said fuel reservoir having a first wall forming a first cavity and a second wall forming a second wall;
a fuel pump having a metal shell disposed in said first cavity of said fuel reservoir to pump fuel therefrom to an engine of the vehicle;
a fuel component disposed in said second cavity of said fuel reservoir; and
at least one grounding clip disposed over said first wall and said second wall and contacting said fuel pump and said fuel component to complete an electrical circuit used for grounding said fuel component.
